(19) United States
(12) Patent Application Publication
(10) Pub. No.: US 2012/0002135 A1
(43) Pub. Date: Jan. 5, 2012

(54) LIGHTING DEVICE, DISPLAY DEVICE AND TELEVISION RECEIVER

(75) Inventor: Koji Hiraguri, Osaka (JP)

(73) Assignee: SHARP KABUSHIKI KAISHA, Osaka-shi, Osaka (JP)

(21) Appl. No.: 13/257,101

(22) PCT Filed: Dec. 21, 2009
(86) PCT No.: PCT/JP2009/071210

§ 371 Date: Sep. 16, 2011

(30) Foreign Application Priority Data
Mar. 25, 2009 (JP) 2009-73996

(51) Int. Cl. G02F 1/1335; F21V 7/00

(52) U.S. Cl. 349/61; 362/609

(57) ABSTRACT

A backlight unit 12 includes a plurality of light source units 16. Each of the light source units 16 includes an LED 20, a light guide plate 22, a first reflecting member 28 and a guidance reflecting member 31. The light guide plate 22 includes a light guide portion 23 and a light exit portion 24. The light guide portion 23 faces the LED 20 and has a light entrance surface 26 which light enters. The light exit portion 24 has a light exit surface 27 that is parallel to an arrangement direction of the LED and the light entrance surface 26 and through which light exits. The light exit portion 24 overlaps the light guide portion 23 in a direction perpendicular to the light exit surface 27 and provided on relatively a light exit side from the light guide portion 23 and formed optically continuous from the light guide portion 23. The first reflecting member 28 is provided between the light guide portion 23 and the light exit portion 24 and configured to reflect light. The guidance reflecting member 31 reflects light from the light guide portion 23 to guide the light to the light exit portion 24. The light source units 16 are arranged in series in at least one direction along the light exit surface 27.

### TECHNICAL FIELD

The present invention relates to a lighting device, a display device and a television receiver.

### BACKGROUND ART

In recent years, displays of image display devices including television receivers are shifting from conventional cathode-ray tube displays to thin-screen displays including liquid crystal panels and plasma display panels. With the thin-screen displays, thin image display devices can be provided. A liquid crystal display device requires a backlight unit as a separate lighting device because a liquid crystal panel used therein is not a light-emitting component.

For example, a liquid crystal display device reducing its thickness and increasing its size disclosed in Patent Document 1 has been known. The liquid crystal display device includes light sources and light guide plates. The light sources emit rays of light in a direction substantially parallel to the display surface of the liquid crystal panel. Each of the light guide plates has a light entrance surface in its side-edge area and a light exit surface on its upper surface. The light entrance surface faces the light source and rays of light emitting from the light source strike the light entrance surface. The rays of light exit through the light exit surface toward the display surface of the liquid crystal panel. A number of sets of the light guide plate and the light source are arranged in series in their arrangement direction and adjacent light guide plates partially overlap each other.

Patent Document 1: Japanese Unexamined Patent Publication No. 2001-93321

### Problem to be Solved by the Invention

In the above-mentioned backlight unit, the adjacent light guide plates overlap each other for the following reason. If an LED having a number of LED chips each of which emits light of a single color is used as the light source, the rays of single color light emitted from each LED chip is required to be mixed while traveling through the light guide plate. In such a case, a certain light path length is necessarily ensured for the rays of light traveling through the light guide plate. Therefore, a light guide portion having no light exit surface may be provided on the light guide plate. If the light guide portion having no light exit surface is bare on the front-surface side, it may be recognized as a dark portion. Therefore, the adjacent light guide plate is provided to overlap the light guide portion.

However, if the light guide plates are arranged to overlap each other, different problems may be caused. If any one of the LEDs has malfunction as a result of a lighting test after each of the light guide plates is arranged, not only the light guide plate corresponding to the LED having malfunction but also all the light guide plates that directly or indirectly overlap the light guide plate are required to be removed. This causes troublesome operations.

### DISCLOSURE OF THE PRESENT INVENTION

The present invention was made in view of the foregoing circumstances. An object of the present invention is to ensure a sufficient light path length of rays of light traveling through a light guide member without overlapping the light guide members.

### Means for Solving the Problem

A lighting device of the present invention includes a plurality of light source units, and each of the light source units includes a light source, a light guide member including a light guide portion and a light exit portion, a reflecting member and a guidance reflecting member. The light guide portion includes a light entrance surface that is provided to face the light source and light emitted from the light source enters. The light exit portion includes a light exit surface that is provided to be parallel to an arrangement direction in which the light source and the light entrance surface are arranged and through which light exits. The light exit portion overlaps the light guide portion in a direction perpendicular to the light exit surface and is provided on relatively a light exit side and optically continuous from the light guide portion. The reflecting member is provided between the light guide portion and the light exit portion and configured to reflect light. The guidance reflecting member is configured to reflect the light from the light guide portion to guide the light to the light exit portion. The light source units are arranged in series in one direction along the light exit surface.

With this configuration, the rays of light emitted from the light source enter the light entrance surface of the light guide portion of the light guide member, and the rays of light reflect off the reflecting member to travel trough the light guide member. The rays of light from the light guide portion reflect off the guidance reflecting member and are guided to the light exit portion that is optically continuous from light guide portion. The rays of light travel through the light exit portion with reflecting off the reflecting member and exit through the light exit surface.

The light guide portion and the light exit portion of the light guide member overlap each other in a direction perpendicular to the light exit surface via the reflecting member. This prevents the light guide portion from being recognized as a dark portion viewed from the light exit surface side. This also ensures a sufficient light path length of light traveling through the light guide member.

A number of light source units are arranged in series in at least one direction along the light exit surface. This is preferable for increasing a size of the device. In the related art, the adjacent light guide members overlap each other in an entire area of the light guide portion. Therefore, the light guide members cannot be separately mounted or removed. In the above configuration, the light guide portion and the light exit portion of the light guide member overlap each other in a direction perpendicular to the light exit surface via the reflecting member. Thus, the light guide member of the light source unit that is adjacent to the light guide portion does not overlap an entire area of the light guide portion. This enables each light guide member to be separately mounted or removed.

### BRIEF DESCRIPTION OF THE DRAWINGS

FIG. 1 is an exploded perspective view illustrating a general construction of a television receiver according to a first embodiment of the present invention;

FIG. 2 is an exploded perspective view illustrating a general construction of a liquid crystal panel and a backlight unit;

FIG. 3 is a cross-sectional view of a liquid crystal display device along the long side thereof;

FIG. 4 is a plan view illustrating a layout of light source units;

FIG. 5 is a cross-sectional view of the light source unit along the long side of the liquid crystal display device;

FIG. 6 is a cross-sectional view of a light source unit according to a first modification of the first embodiment;

FIG. 7 is a cross-sectional view of a light source unit according to a second modification of the first embodiment;

FIG. 8 is a cross-sectional view of a light source unit according to a third modification of the first embodiment;

FIG. 9 is a cross-sectional view of a light source unit according to a fourth modification of the first embodiment;

FIG. 10 is a cross-sectional view of a light source unit according to a fifth modification of the first embodiment;

FIG. 11 is a cross-sectional view of a light source unit according to a second embodiment of the present invention;

FIG. 12 is a plan view illustrating a layout of light source units according to a third embodiment of the present invention; and

FIG. 13 is a cross-sectional view of a light source unit according to a fourth embodiment of the present invention.

### BEST MODE FOR CARRYING OUT THE INVENTION

### First Embodiment

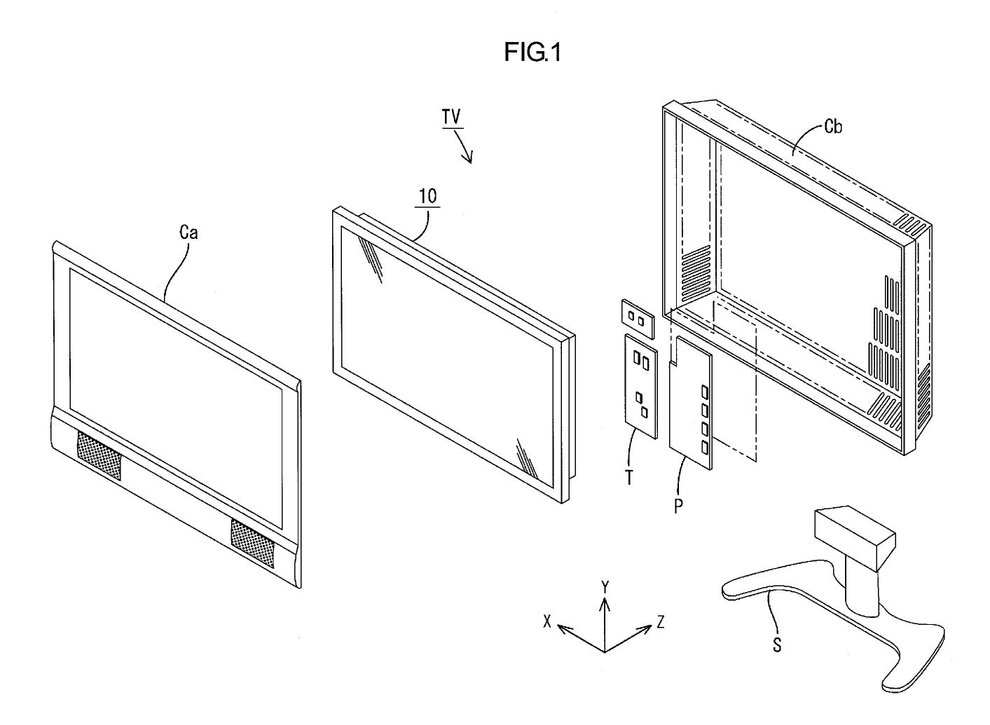

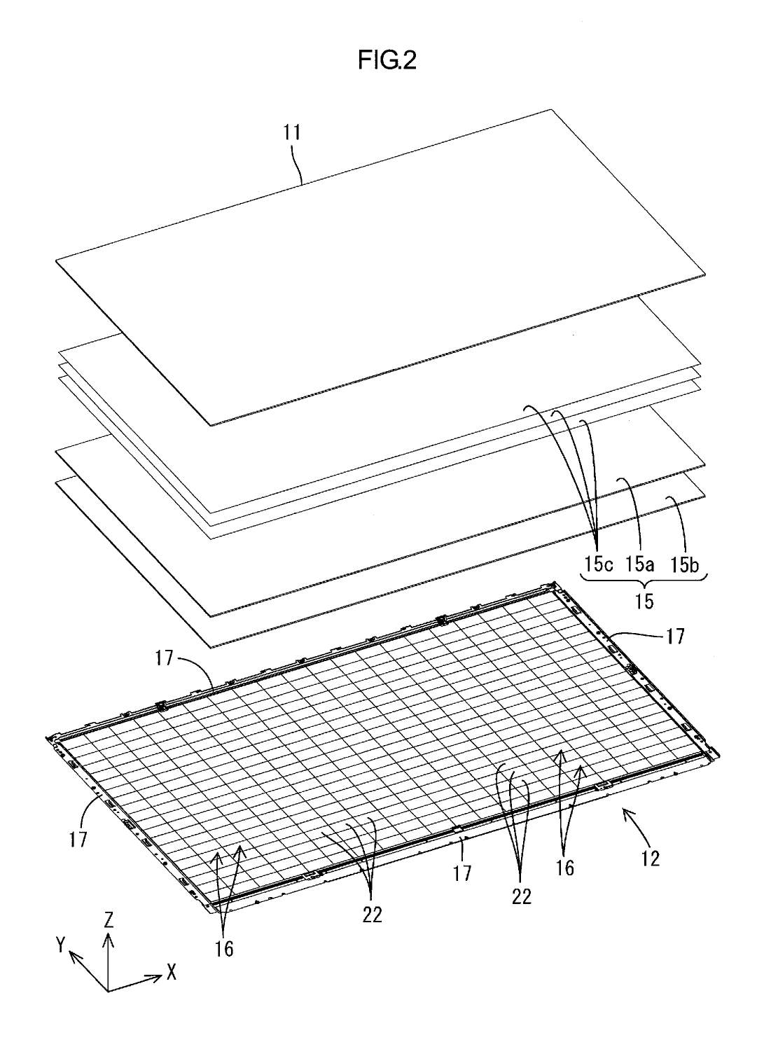

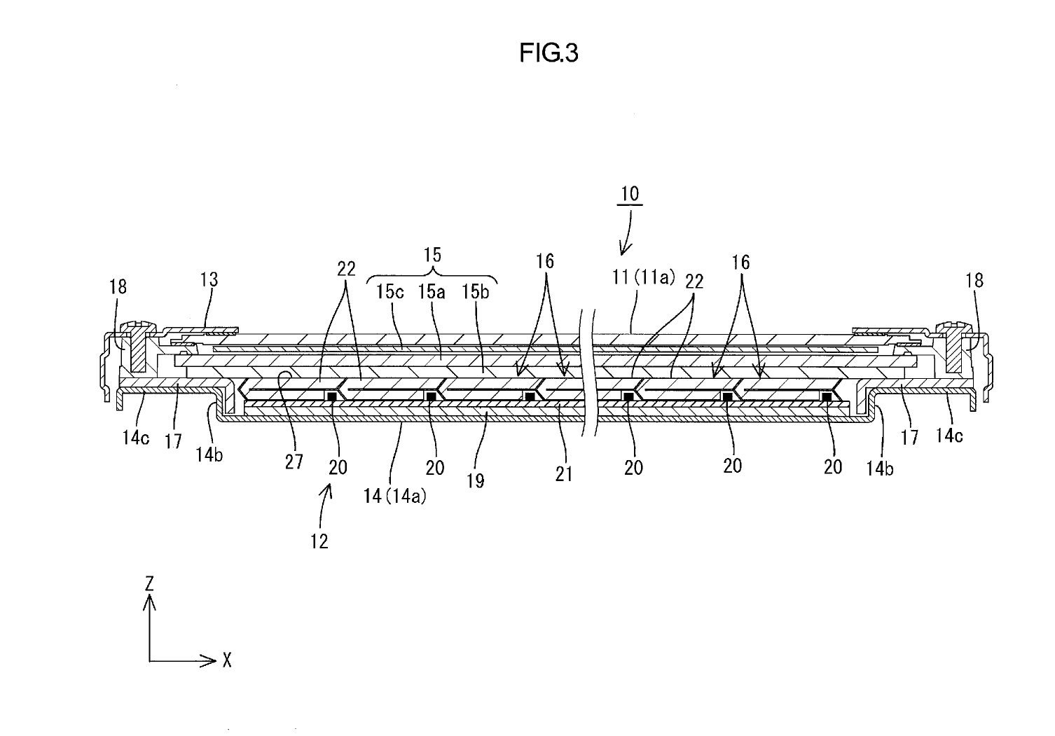

The first embodiment of the present invention will be explained with reference to FIGS. 1 to 5. In this embodiment, a liquid crystal display device 10 will be explained. X-axes, Y-axes and Z-axes in some figures correspond to each other so as to indicate the respective directions. In FIGS. 2 and 3, the upper side and the lower side correspond to the front-surface side and the rear-surface side, respectively.

As illustrated in FIG. 1, the television receiver TV includes the liquid crystal display device 10 (a display device), cabinets Ca and Cb, a power source P, and a tuner T. The cabinets Ca and Cb sandwich the liquid crystal display device 10 therebetween. The liquid crystal display device 10 is housed in the cabinets Ca and Cb. The liquid crystal display device 10 is held by a stand S in a vertical position in which a display surface 11a is set along a substantially vertical direction (the Y-axis direction). The liquid crystal display device 10 has a landscape rectangular overall shape. As illustrated in FIG. 2, the liquid crystal display device 10 includes a liquid crystal panel 11 (an example of a display panel), which is a display panel, and a backlight unit 12 (an example of a lighting device), which is an external light source. The liquid crystal panel 11 and the backlight unit 12 are held together by a frame-shaped bezel 13 as illustrated in FIG. 2.

“The display surface 11a is set along the vertical direction” is not limited to a condition that the display surface 11a is set parallel to the vertical direction. The display surface 11a may be set along a direction closer to the vertical direction than the horizontal direction. For example, the display surface 11a may be 0° to 45° slanted to the vertical direction, preferably 0° to 30° slanted.

Next, the liquid crystal panel 11 and the backlight unit 12 included in the liquid crystal display device 10 will be explained. The liquid crystal panel 11 has a rectangular plan view and includes a pair of transparent glass substrates bonded together with a predetermined gap therebetween and liquid crystals sealed between the substrates. On one of the glass substrates, switching components (e.g., TFTs), pixel electrodes and an alignment film are arranged. The switching components are connected to gate lines and the source lines that are perpendicular to each other. The pixel electrodes are connected to the switching components. On the other glass substrate, color filters including R (red) G (green) B (blue) color sections in predetermined arrangement, a counter electrode and an alignment film are arranged. Polarizing plates are arranged on outer surfaces of the glass substrates, respectively.

Next, the backlight unit 12 will be explained in detail. As illustrated in FIG. 3, the backlight unit 12 includes a chassis 14, an optical member 15 and a number of light source units 16. The chassis 14 has a box-like overall shape and an opening on the front side (the liquid crystal panel 11 side, the light output side). The optical member 15 is arranged so as to cover the opening. The light source units 16 are mounted in the chassis 14. The backlight unit 12 further includes a support member 17, a holddown member 18 and a heat sink 19. The support member 17 holds diffusers 15a and 15b included in the optical member 15 from the rear side. The holddown member 18 holds down the diffusers 15a and 15b from the front side. The heat sink 19 is provided for dissipation of heat generated while an LED 20 of the light source unit 16 emits light.

Next, components of the backlight unit 12 will be explained in detail. The chassis 14 is made of metal and has a shallow-box-like overall shape (or a shallow-bowl-like overall shape) with the opening on the front-surface side. The chassis 14 includes a bottom plate 14a, side plates 14b and support plates 14c. The bottom plate 14a has a rectangular shape similar to the liquid crystal panel 11. The side plates 14b rise from the respective edges of the bottom plate 14a. The support plates 14c project outward from the respective end edges of the side plates 14b. The long-side direction and the short-side direction of the chassis 14 correspond to the horizontal direction (the X-axis direction) and the vertical direction (the Y-axis direction), respectively. The support plates 14c of the chassis 14 are configured such that the support member 17 and the holddown member 18 are placed thereon, respectively, from the front-surface side. Amounting structure (not shown) for mounting a light guide plate 22 and an LED board 21 that configure the light source unit 16 is provided on the bottom plate 14a. The mounting structure may be a screw hole in which a screw member is screwed up or a screw insertion hole through which a screw member is inserted when the light guide plate 22 or the LED board 21 is mounted with screw members. Each support plate 14c holds a bezel 13, the support member 17 and the holddown member 18 together with screws.

The optical member 15 is arranged between the liquid crystal panel 11 and the light source units 16. It includes the diffusers 15a and 15b arranged on the light guide plate 18 side, and an optical sheet 15c arranged on the liquid crystal panel 11 side. Each of the diffusers 15a and 15b includes a transparent resin base material with a predefined thickness and a large number of diffusing particles scattered in the base material. The diffusers 15a and 15b have functions of diffusing light that passes therethrough. The diffusers 15a and 15b having the same thickness are placed on top of each other. The optical sheet 15c is a thin sheet having a smaller thickness than that of the diffusers 15a and 15b. The optical sheet 15c includes three sheets placed on top of each other, more specifically, a diffusing sheet, a lens sheet and a reflection-type polarizing sheet arranged in this order from the diffuser 15a (15b) side (i.e., from the rear-surface side).

The support member 17 and the holddown member 18 are formed in a frame-like shape so as to follow outer peripheral edge portions of the liquid crystal panel 11 and the optical member 15. The support member 17 is placed directly on the support plate 14c of the chassis 14 and supports outer peripheral edge portions of the diffuser 15b of the optical member on a rear-surface side. The holddown member 18 is placed on the support member 19 and holds down the diffuser 15a of the optical member 15 on the front-surface side from the front-surface side. Therefore, the two diffusers 15a, 15b are held between the support member 17 and the holddown member 18. The holddown member 18 supports the outer peripheral edge portions of the liquid crystal panel 11 from the rear-surface side. The liquid crystal panel 11 is held between the holddown member 20 and the bezel 13 that holds down the outer peripheral edge portions of the liquid crystal panel 11 from the front-surface side. The bezel 13 is also formed in a frame-like shape so as to surround a display area of the liquid crystal panel 11 like the support member 17 and the holddown member 18.

The heat sink 19 is made of synthetic resin or metal having high thermal conductivity and formed in a sheet-like shape. The heat sink 19 extends along an inner surface of the bottom plate 14a of the chassis 14. The heat sink 19 is placed between the bottom plate 14a of the chassis 14 and the light source unit 16.

Next, the light source unit 16 will be explained in detail. As illustrated in FIG. 2, the light source units 16 are arranged two-dimensionally in series along the display surface 11a (in a plane arrangement). In other words, the light source units 16 are arranged in series in the X-axis direction (in a row) and also in the Y-axis direction (in a column), and the light source units 16 are arranged in rows and columns. Each light source unit 16 faces a rear surface of the optical member 15 and has a light exit surface 27 that is parallel to a plate surface of the optical member 15 (a display surface 11a). Each of the light source units 16 can emits light through the light exit surface 27 independently from each other. Each light source unit 16 includes an LED 20 (light emitting diode) as the light source, an LED board 21 on which an LED 20 is mounted and a light guide plate 22 that guides rays of light emitted from the LED 20 to the optical member 15. The light guide plate 22 includes light reflecting portions 28, 29 that guide the light to efficiently travel through the light guide plate 22.

The LED board 21 is made of synthetic resin and the surface thereof is in white that provides high light reflectivity. The LED board 21 is formed in a rectangular plate-like shape with planar view. A number of the LED boards 21 are arranged in a plane in a grid on a surface area of the bottom plate 14a of the chassis 14. Each of the LED boards 21 is placed on the heat sink 19. Wiring patterns that are metal films are formed on each LED board 21 and the LEDs 20 are mounted in predetermined locations on the LED board 21. The LED board 21 is connected to an external control board, which is not illustrated in the figures. The control board is configured to feed currents for turning on the LEDs 20 and to perform driving control of the LEDs 20. A mounting structure (not illustrated) for mounting the LED board 21 to the chassis 14 is provided on the LED board 21. In mounting with screw members, screw holes in which the screw members are screwed up or screw insertion holes through which the screw members are inserted are provided as the mounting structure. Such a mounting structure is also provided on the light guide plate 22 and the same explanation thereof will be omitted.

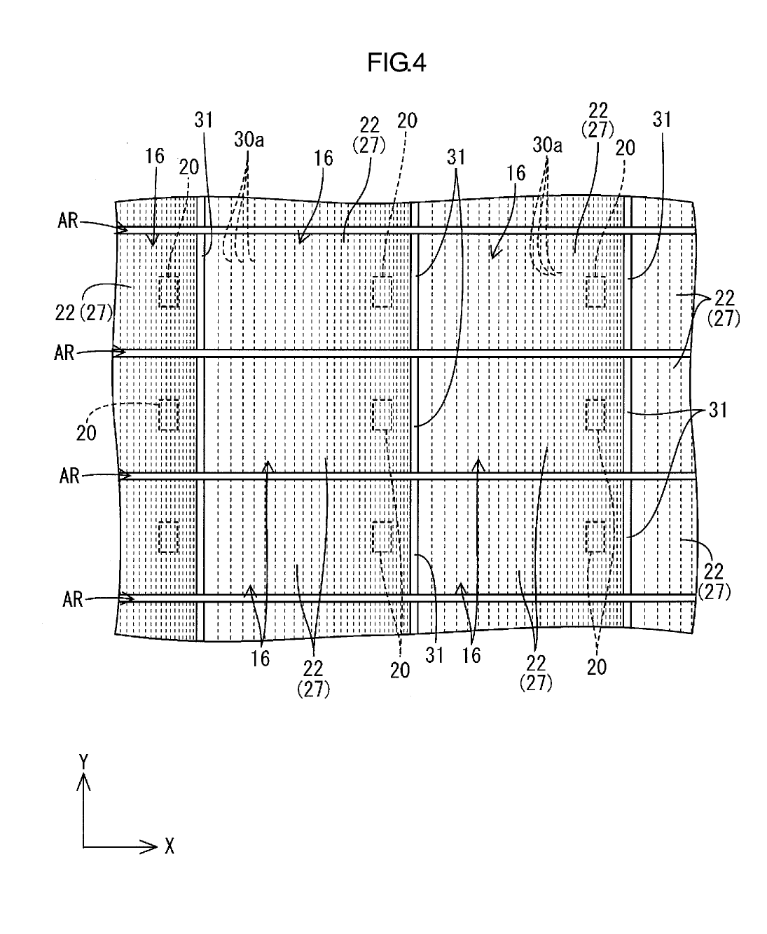

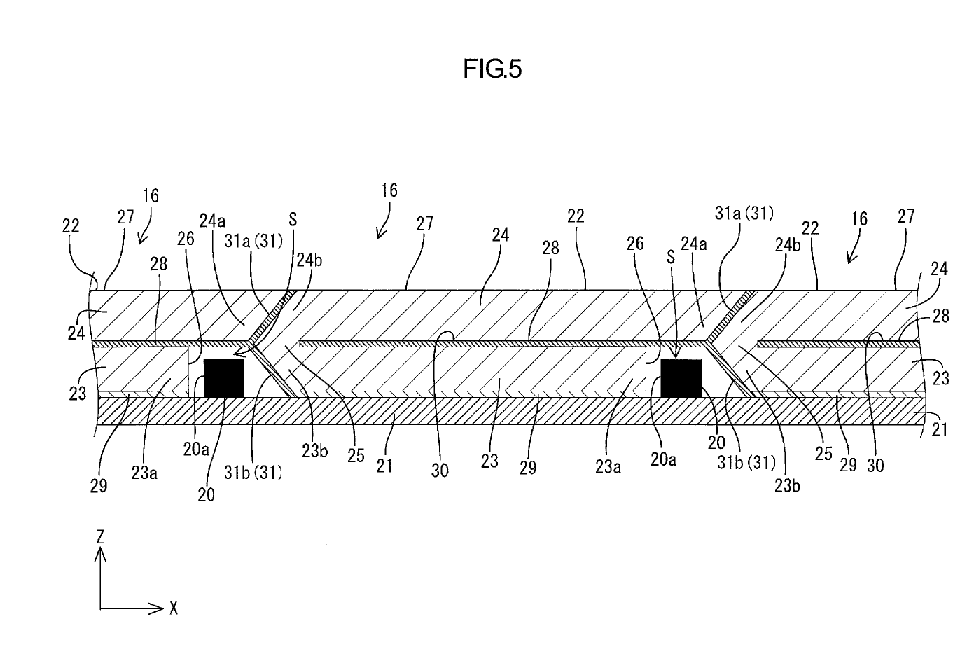

The LEDs 20 are surface-mounted to the LED board 21, that is, the LEDs 20 are surface-mount LEDs. As illustrated in FIGS. 4 and 5, a number of LEDs 20 are arranged in a planar grid pattern (in rows and columns) in the X-axis direction and in the Y-axis direction on a front surface of the LED board 21. Each LED 20 has a substantially block-like overall shape. The LED 20 is configured by sealing the LED chip by a resin member on a board that is to be fixed to the LED board 21. The LED chip mounted on the board includes three different kinds of LED chips with different main emission wavelengths. Specifically, each LED chip emits a single color of light of R (red), G (green) or B (blue). The LED 20 is a side-surface light emission type and a light emitting surface 20a is provided on only one side surface of the LED 20 that is close to a mounting surface to the LED board 21. Each LED 20 is arranged on the LED board 21 such that the light emitting surface 20a faces leftward in FIG. 5. The light axis of rays of light emitted from the LED 20 substantially matches the X-axis direction (an arrangement direction of the LED 20 and a light entrance surface 26) and is substantially parallel to the display surface 11a of the liquid crystal panel 11 (the light exit surface 27 of the light guide plate 22). Rays of light emitted from the LED 20 radiate three-dimensionally around the light axis in a specific angle range. The directivity thereof is higher than cold cathode tubes. Namely, angle distributions of the LED 20 shows a tendency that the emission intensity of the LED 20 is significantly high along the light axis and sharply decreases as the angle to the light axis increases.

The light guide plates 22 are provided between the LED board 21 and the diffuser 15b that is on the rear-surface side of the optical member 15 in the Z-axis direction as illustrated in FIG. 3. As illustrated in FIG. 4, a number of the light guide plates 22 are arranged to correspond to the LEDs 20 respectively in two-dimensionally in the X-axis direction and in the Y-axis direction. Namely, the light guide plates 22 are arranged in series in rows (in the X-axis direction) and columns (in the Y-axis direction) (in a grid pattern or with being tiled). The light guide plates 18 are arranged to have a predetermined gap (space, clearance) between the adjacent light guide plates 22 in the Y-axis direction that is between the lines each including the light guide plates 22 arranged in the X-axis direction. An air layer AR having a lower refractive index relative to the light guide plate 22 is provided in the gap.

The light guide plate 22 is made of substantially transparent (i.e., having high light transmission capability) synthetic resin (e.g. polycarbonate), a refractive index of which is significantly higher than that of air. As illustrated in FIGS. 4 and 5, the light guide plate 22 has substantially a plate-like shape having a rectangular overall plan view. The long-side direction of the light guide plate 22 matches the X-axis direction and the short-side direction thereof matches the Y-axis direction.

As illustrated in FIG. 5, the light guide plate 22 is folded in half. The light guide plate 22 includes a light guide portion 23 and a light exit portion 24 that are overlapped with each other in the Z-axis direction (a direction perpendicular to the light exit surface 27). The light guide portion 23 ensures a light path length of rays of light emitted from the LED 20. The light exits through the light exit portion 24 toward the optical member 15. One end portion (front end portion 23b) of the light guide portion 23 and one end portion (front end portion 24b) of the light exit portion 24 are optically and mechanically connected to each other via a connecting portion 25. At a first end portion of the light guide plate 22 in the X-axis direction, an upper end portion and a lower end portion are optically independent from each other. At a second end portion of the light guide plate 22 that is opposite end of the first end portion, an upper end portion and a lower end portion are optically connected to each other via the connecting portion 25.

In the following, a side closer to the second end portion from the first end portion in the X-axis direction (a light emitting direction of light emitted from the LED 20, a leftward in FIG. 5) is frontward, and a side closer to the first end portion from the second end portion (a rightward in FIG. 5) is rearward.

The light guide portion 23 is provided to overlap the light exit portion 24 on a relatively rear side (an opposite side from the light exit side) and formed in substantially a plate-like shape extending along the LED board 21. A rear end portion 23a of the light guide portion 23 is provided at a frontward (an inner side) from a rear end portion 24a of the light exit portion 24. A portion of the light guide portion 23 that is to overlap the rear end portion 24a of the light exit portion 24 is partially cut out, and a cutout space is formed as an LED housing space S that can house the LED 20 therein. A light entrance surface 26 that forms an inner wall surface for forming the LED housing space S is formed at the rear end portion 23a of the light guide portion 23 (an end portion opposite from the connecting portion 25). The light entrance surface 26 faces the light emitting surface 20a of the LED 20 and light emitted from the LED 20 enters the light entrance surface 26. The rear end portion 23a of the light guide portion 23 corresponds to the light supply side. The light entrance surface 26 is substantially parallel to a surface along the Z axis and the Y axis, that is, substantially parallel to the light emitting surface 20a. An arrangement direction of the LED 20 and the light entrance surface 26 matches the X-axis direction.

The light exit portion 24 is provided to overlap the light guide portion 23 on a relatively front-surface side (the light exit side) and formed in substantially a plate-like shape extending along the light guide portion 23. Light emitted from the LED 20 is guided to the light exit portion 24 from the front side via the front end portion 23b of the light guide portion 23 and the connecting portion 25. The front end portion 24b is a light supply side of the light exit portion 24. A surface of the light exit portion 24 that faces front-surface side, that is a surface of the light exit portion 24 on an opposite side from the light guide portion 23 is the light exit surface 27. Light traveling through the light exit portion 24 exits through the light exit surface 27 toward the optical member 15. The light exit surface 27 is a surface along the X axis and the Y axis, that is a surface along an arrangement direction of the LED 20 and the light entrance surface 26. The configuration of the front end portion 24b of the light exit portion 24 in the X-axis direction is substantially same as that of the front end portion 23b of the light guide plate 23.

The above-described light guide portion 23 and light exit portion 24 overlap each other with planar view. The light guide portion 23 is provided on a relatively rear-surface side and the light exit portion 24 is provided on a relatively front-surface side. Therefore, if the light guide plate 22 is viewed from the front-surface side, the light guide portion 23 is behind the rear-surface side of the light guide portion 24. A first reflecting member 28 that reflects light is provided between the light guide portion 23 and the light exit portion 24. The first reflecting member 28 is provided on a surface of the light guide portion 23 on a front-surface side and also provided on a surface of the light exit portion 24 on a rear-surface side, that is a surface opposite from the light exit surface 27. Further, a second reflecting member 29 is provided on a surface of the light guide portion 23 on a rear-surface side, that is a surface opposite from the first reflecting member 28. The second reflecting member 29 reflects light traveling in the light guide portion 23 with the first reflecting member 28. Therefore, the light guide portion 23 is sandwiched between the first reflecting member 28 and the second reflecting member 29.

The first reflecting member 28 is made of synthetic resin and the surface thereof is in white that provides high light reflectivity. The first reflecting member 28 is formed in a sheet extending along facing surfaces of the light guide portion 23 and the light exit portion 24. The first reflecting member 28 is provided over entire areas of the light guide portion 23 and the light exit portion 24 excluding the front end portions 23b, 24b (the connecting portion 25). In addition to excellent light reflectivity, an excellent light blocking effect is provided to the first reflecting member 28. Therefore, rays of light do not travel between the light guide portion 23 and the light exit portion 24 in areas of the light guide portion 23 and the light exit portion 24 excluding the front end portions 23b, 24b (including the rear end portions 23a, 24a). The first reflecting member 28 covers the LED housing space S (the LED 20) of the light guide portion 23 from the front-surface side such that the LED housing space S is optically independent from the light output portion 24.

Similar to the first reflecting member 28, the second reflecting member 29 is made of synthetic resin and the surface thereof is in white that provides high light reflectivity. The second reflecting member 29 is formed in a sheet extending along facing surfaces of the light guide portion 23 and the LED board 21. The second reflecting member 29 is provided over an entire area of the light guide portion 23 on a rear-surface side. The light traveling through the light guide portion 23 reflects off the first reflecting member 28 and the second reflecting member 29 alternately. Accordingly, the light traveling through the light guide portion 23 is effectively guided to the connecting portion 25. A rear end surface of the second reflecting member 29 is substantially on a same surface plane with the light entrance surface 26.

A scattering structure is formed on a surface of the first reflecting member 28 on a front-surface side that faces the light exit portion 24. The light scattering structure scatters light to accelerate light to exit through the light exit surface 27. A surface of the first reflecting member 28 is processed to form microscopic asperities thereon to form a scattering surface 30, and thus the scattering structure is formed. The scattering structure scatters the light traveling through the light guide portion 24 on an interface of the scattering surface 30. Accordingly, the rays of light are directed to the light exit surface 27 and strike the light exit surface 27 at the incident angles smaller than the critical angle (light is not totally-reflected) and light exits through the light exit surface 27 to outside. As illustrated in FIG. 4, the scattering surface 30 has a number of lines of perforations 30a that extend straight along the Y-axis direction. The perforations 30a are arranged parallel to each other at predetermined intervals. The arrangement pitch of the perforations 30a is smaller on the rear end portion 24a side of the light exit portion 24 than the front end portion 24b side. Namely, the arrangement pitch of the perforations 30a is smaller as it is farther from the light supply side. The perforations 30a forming the scattering surface 30 are arranged in a gradational arrangement as follows. The closer to the front end side or the connecting portion 25, the lower the distribution density of the perforations 30a becomes, and the farther from the rear end side or the connecting portion 25, the higher the distribution density of the perforations 30a becomes. Accordingly, brightness difference is not caused between a portion of the light exit portion 24 closer to the connecting portion 25 and a portion farther from the connecting portion 25. This achieves a uniform brightness distribution in a surface area of the light exit surface 27.

The connecting portion 25 is integrally molded with the light guide portion 23 and the light exit portion 24 in molding the light guide plate 22 with resin. Therefore, the light guide portion 23, the connecting portion 25 and the light exit portion 24 are continuously formed in a seamless manner, and light traveling through the light guide plate 22 is not refracted at the borders of the light guide portion 23, the connecting portion 25 and the light exit portion 24. As described before, the connecting portion 25 is provided only at the front end portion 23b of the light guide portion 23 and the front end portion 24b of the light exit portion 24 and not provided at the rear end portions 23a, 24a. Therefore, the light guide plate 22 has directivity in a front-and-rear direction.

A pair of slanted surfaces each having a different slanted angle is formed at the front end surface of the light guide plate 22. One of the slanted surfaces on a relatively front side is slanted at an obtuse angle to the light exit surface 27 and another one on a relatively rear side is slanted at an obtuse angle to the second reflecting member 29 (a surface of the light guide plate 22 on the rear-surface side). A guidance reflecting member 31 is provided at the front end surface of the light guide plate 22. The guidance reflecting member 31 guides light from the light guide portion 23 to the light exit portion 24. The guidance reflecting member 31 is made of synthetic resin and the surface thereof is in white that provides high light reflectivity. The guidance reflecting member 31 extends along the slanted surfaces. The guidance reflecting member 31 is configured by a first guidance reflecting member 31a and a second guidance reflecting member 31b. The first guidance reflecting member 31a is provided on a relatively front-surface side and slanted at an obtuse angle to the light exit surface 27 and the second guidance reflecting member 31b is provided on a relatively rear-surface side and slanted at an obtuse angle to the second reflecting member 29. The first guidance reflecting member 31a and the second guidance reflecting member 31b each of which has a different slanted angle reflect light from the light guide portion 23 to efficiently guide the light to the light output portion 24 side. A bent portion of the guidance reflecting member 31 is formed at a border of the first guidance reflecting member 31a and the second guidance reflecting member 31b. The bent portion is located at substantially the middle of the light guide plate 22 in the Z-axis direction, that is at a substantially same position in the Z-axis direction as the first reflecting member 28. This ensures a maximum clearance between the guidance reflecting member 31 and the first reflecting member 28. In other words, this ensures a maximum light path width (a size of the connecting portion 25 in the X-axis direction) that connects the light guide portion 23 and the light exit portion 24. An angle between the first guidance reflecting member 31a and the light exit surface 27 is substantially equal to an angle between the second guidance reflecting member 31b and the second reflecting member 29. An obtuse angle is formed between the first guidance reflecting member 31a and the second guidance reflecting member 31b.

As mentioned before, the light source unit 16 of the present embodiment is configured to have directivity and the light source units 16 are arranged in two-dimensionally in the X-axis direction and the Y-axis direction. As illustrated in FIGS. 4 and 5, the light source units 16 arranged in the X-axis direction so as to head for the same direction. Namely, each of the light guide plates 22 arranged in the X-axis direction such that the first end portion is located on the rear side and the second end portion is located on the front side and each LED 20 is arranged on the rear end side of the light guide plate 22 corresponding to the first end portion. Therefore, the first end portion (the rear end portions 23a, 24a) of the light guide plate 22 that is arranged on a relatively front side and the second end portion (the front end portions 23b, 24b) of the light guide plate 22 that is arranged on a relatively rear side are arranged in adjacent to each other with the guidance reflecting member 31 intervening therebetween.

Each of the light guide plates 22 that are arranged in adjacent to each other in the X-axis direction is formed in a complementary shape. A rear end surface of the rear end portion 24a of the light exit portion 24 of the light guide plate 22 that is arranged on a relatively front side and a front end surface of the front end portion 24b of the light exit portion 24 of the light guide plate 22 that is arranged on a relatively rear side have slanted surfaces that are mutually complementary. The rear end surface of the rear end portion 24a of the light exit portion 24 of the light guide plate 22 that is arranged on a relatively front side is a surface slanted at an acute angle to the light exit surface 27. The front end surface of the front end portion 24b of the light exit portion 24 of the light guide plate 22 that is arranged on a relatively rear side is a surface slanted a an obtuse angle to the light exit surface 27. A total of the slanted angles of the slanted surfaces is 180 degrees.

Also, the guidance reflecting member 31 is provided between the light guide plates 22 that are arranged in adjacent to each other in the X-axis direction. The guidance reflecting member 31 is excellent in light reflectivity and a light blocking property. Therefore, the guidance reflecting member 31 provided between the light guide plates 22 that are arranged in adjacent to each other in the front-and-rear direction prevents rays of light from traveling between the light guide plates 22 that are arranged in adjacent to each other in the front-and-rear direction. This ensures mutual optical independency of the light source units 16 that are arranged in adjacent to each other in the front-and-rear direction. Namely, the guidance reflecting member 31 has a function of reflecting and guiding light traveling through the light guide plate 22 and a function of optically separating from each other the light guide plates 22 that are arranged in adjacent to each other in the front-and-rear direction. Accordingly, a distance between the light exit surfaces 27 that are arranged in adjacent to each other in the X-axis direction is approximately equal to a thickness of the guidance reflecting member 31 that is a minimum size. The guidance reflecting member 31 provided between the adjacent light exit surfaces 27 may be recognized as a dark portion that is relatively darker compared to the light exit surface 27. However, the possible dark portion is restricted to be in a minimum size. This achieves a uniform brightness distribution in a surface area of the light exit surface of the backlight unit 12. Further, a surface of the guidance reflecting member 31 facing the front-surface side is on a same plane as the light exit surface 27. The light exit surfaces 27 that are arranged in adjacent to each other in the X-axis direction are continuously connected to each other via the guidance reflecting member 31 without causing any steps or gaps. Therefore, uneven brightness is less likely to be caused. The guidance reflecting members 31 are linearly arranged in series in the Y-axis direction similar to the light guide plates 22 and the LEDs 20 (FIG. 4).

The first guidance reflecting member 31a of the guidance reflecting member 31 is provided between the rear end surface of the rear end portion 24a of the light exit portion 24 of the light guide plate 22 that is provided on a relatively front side and the front end surface of the front end portion 24b of the light exit portion 24 of the light guide plate 22 that is provided at a relatively rear side of the light guide plate 22 provided on a relatively front side. The second guidance reflecting member 31b is provided between the LED housing space S in the light guide plate 22 that is provided on a relatively front side and the front end portion 23b of the light guide portion 23 of the light guide plate 22 that is arranged on a relatively rear side of the light guide plate provided on a relatively front side. The guidance reflecting member 31 that reflects and guides the light traveling through the light guide plate 22 provided on a relatively rear side is integrally formed with the first reflecting member 28 that comprises the light source unit 16 arranged on a relatively front side. The bent portion of the guidance reflecting member 31 (the border position between the first guidance reflecting member 31a and the second guidance reflecting member 31b) is integrally connected to the rear end portion of the first reflecting member 28 arranged on a relatively front side.

The configuration of the present embodiment has been explained above and operations thereof will be explained. Assembling steps of the backlight unit 12 will be explained briefly. After the heat sink 19 is housed in the chassis 14, the LED board 21 having the LEDs 20 mounted thereon is housed in the chassis 14. Thereafter, the light guide plates 22 each of which integrally includes the reflecting members 28, 29 and the guidance reflecting member 31 are mounted on the LED board 21. In the above assembling steps, after a light guide plate 22 is first mounted in the rear end position of the chassis 14 in the X-axis direction, a next light guide plate 22 is mounted in the front side position of the light guide plate 22 that has been mounted. This operation will be repeatedly executed. In mounting of each light guide plate 22, the light guide plate 22 is mounted on the LED board 21 from the front side such that the LED housing space S is positioned to correspond to the LED 20. In the mounting of the light guide plate 22, it is preferable that the guidance reflecting member 31 arranged on a relatively front side is in contact with the front end surface of the light guide plate 22 arranged on a relatively rear side not to generate any gap therebetween. Accordingly, the light guide plates 22 are arranged in series, that is, in a tandem layout such that all the light guide plates 22 head for the same direction in the X-axis direction (FIG. 2). The light guide plates 22 are thus arranged in series in a tandem layout sequentially for each row. Accordingly, the light guide plates 22 are arranged in series in rows and columns (two-dimensionally). In the mounting steps of the light guide plates 22, after a light guide plate 22 may be first mounted in the front end position of the chassis in the X-axis direction, a next light guide plate 22 may be mounted in the rear-side position of the light guide plate 22 that has been mounted. This process may be repeatedly executed.

After the light guide plates 22 are mounted as mentioned above, a lighting test may be executed for each LED 20. The lighting test is executed to detect a malfunction or any problems in each component (the LED 20, the LED board 21 and the light guide plate 22 or other components) of the light source unit 16. If any problem is detected in the individual LED 20 or the individual LED board 21 by the lighting test, the LED 20 or the LED board 21 is required to be repaired or replaced with new one. In such a case, the light guide plate 22 that is mounted on the front side of the LED board 21 is required to be removed. According to the present embodiment, each light guide plate 22 is configured such that the light guide portion 23 overlaps the light exit portion 24 in the Z-axis direction and the light guide plates that are in adjacent to each other in the X-axis direction partially overlap each other in the Z-axis direction. Therefore, an individual one of the light guide plates 22 that are arranged in series in the X-axis direction is easily removed.

The front end portion 24b of the light exit portion 24 of the middle light guide plate 22 in FIG. 5 overlaps a rear side of the rear end portion 24a of the light exit portion 24 of the light guide plate 22 arranged on a front side of the middle light guide plate 22. The rear end portion 24a of the light exit portion 24 of the middle light guide plate 22 in FIG. 5 overlaps a front side of the front end portion 24b of the light exit portion 24 of the light guide plate 33 arranged on a rear side of the middle light guide plate 22. Therefore, to remove the middle light guide plate 22 in FIG. 5, the rear end portion 24a (the first end portion) of the light exit portion 24 of the light guide plate 22 is first lifted up. Accordingly, the front end portion 24b (the second end portion) on which the rear end portion 24a of the light exit portion 24 of the light guide plate 22 arranged on a front side is located is easily removed. This improves operability in removing the individual light guide plate 22.

After the lighting test, other members are assembled to complete the assembling of the backlight unit 12 and the liquid crystal display device 10. If the power source of the liquid crystal display device 10 is turned on and the LEDs 20 are lit on, rays of light exiting from the light emitting surface 20a of the LED 20 strikes and enters the light entrance surface 26 of the light guide plate 22. The LED housing space S is defined separately from the light guide plate 22 arranged on a relatively rear side by the second guidance reflecting member 31b of the guidance reflecting member 31. Therefore, the rays of light traveling in the LED housing space S do not enter the light guide plate 22 that is arranged on a relatively rear side.

The rays of light entering the light guide portion 23 from the light entrance surface 26 reflect off the first guidance reflecting member 28 and the second guidance reflecting member 29 several times to travel frontward (toward the connecting portion 25). While the rays of light are traveling through the light guide portion 23, each single color light emitted from each LED chip included in the LED 20 is mixed with each other. The rays of light traveling to the front end portion 23b of the light guide portion 23 reflect off the slanted guidance reflecting member 31 to be directed to the light exit portion 24. Then, the rays of light travel through the connecting portion 25 toward the front end portion 24b of the light exit portion 24 effectively. The slanted angles of the first guidance reflecting member 31a and the second guidance reflecting member 31b of the guidance reflecting member 31 are controlled such that the entrance angle of rays of light entering the light exit surface 27 is greater than a critical angle. Accordingly, the rays of light reaching the light exit portion 24 directly strike the light exit surface 27 and totally reflect off the light exit surface 27 to be returned to the first reflecting member 28. The rays of light reflect off the first reflecting member 28 again to be directed to the light exit surface 27. This operation will be repeatedly executed. A part of the rays of light reaching the light exit portion 24 first strikes the first reflecting member 28 to be directed to the light exit surface 27. Thus, the rays of light travel through the light exit portion 24 rearward by repeatedly reflecting off the light exit surface 27 and the first reflecting member 28.

A part of the rays of light traveling through the light exit portion 24 is scattered by the scattering structure formed on the surface of the first reflecting member 28 during the traveling. An incident angle of a part of the rays of light that is scattered and directed to the light exit surface 27 and strikes the light exit surface 27 is not greater than the critical angle and the light is exited to outside through the light exit surface 27 on the front-surface side. The scattering structure is configured such that the degree of light scattering increases in a continuous and gradual manner from the front end portion 24b (the connecting portion 25) side to the rear end portion 24a. Light emission is restricted on the rear end portion 24b side in which the amount of rays of light traveling through the light exit portion 24 is relatively great and light emission is accelerated on the front end portion 24a side in which the amount of rays of light traveling through the light exit surface 27 is small. This achieves a uniform distribution of light emitted through a surface area of the light exit surface 27. Accordingly, uneven brightness is less likely to occur. While transmitting through the diffuser plates 15a, 15b and the optical sheets 15c, the rays of light exited from each light guide plate 22 are dispersed uniformly in a surface area of the light exit surface of the backlight device 12 to be substantially a planar light and irradiated to the liquid crystal panel 11.

As explained before, the backlight unit 12 of the present embodiment includes the light source units 16. Each of the light source units 16 includes the LED 20, the light guide plate 22, the first reflecting member 28 and the guidance reflecting member 31. The light guide plate 22 includes the light guide portion 23, the light exit surface 27 and the light exit portion 24. The light guide portion 23 includes the light entrance surface 26 facing the LED 20 and which rays of light strike and enter. The light exit surface 27 is parallel to an arrangement direction of the LED 20 and the light entrance surface 26 (the X-axis direction) and rays of light exit through the light exit surface 27. The light exit portion 24 overlaps the light guide portion 23 in a direction perpendicular to the light exit surface 27 (the Z-axis direction) and is arranged on a relatively light exit side and optically connected to the light guide portion 23. The first reflecting member 28 is provided between the light guide portion 23 and the light exit portion 24 and reflect the rays of light. The guidance reflecting member 31 reflects and guide rays of light from the light guide portion 23 toward the light exit portion 24. The light source units 16 are arranged in series in at least one direction along the light exit surface 27.

With such a configuration, rays of light emitted from the LED 20 strikes and enters the light entrance surface 26 of the light guide portion 23 of the light guide plate 22. The rays of light travel through the light guide portion 23 with reflecting off the first reflecting member 28. The rays of light from the light guide portion 23 reflect off the guidance reflecting member 31 to be guided to the light exit portion 24 that is optically connected to the light guide portion 23. The rays of light travel through the light exit portion 24 with reflecting off the first reflecting member 28 and exit through the light exit surface 27.

The light guide portion 23 and the light exit portion 24 of the light guide plate 22 overlap each other in a direction perpendicular to the light exit surface 27 via the first reflecting member 28. This prevents the light guide portion 23 from being recognized as a dark portion viewed from the light exit surface 27 side. This also ensures a sufficient light path length of light traveling through the light guide plate 22.

A number of light source units 16 are arranged in series in at least one direction along the light exit surface 27. This is preferable for increasing a size of the device. In the related art, the adjacent light guide plates overlap each other in an entire area of the light guide portion. Therefore, the light guide plates cannot be separately mounted or removed. In the above configuration, the light guide portion 23 and the light exit portion 24 of the light guide plate 22 overlap each other in a direction perpendicular to the light exit surface 27 via the first reflecting member 28. Thus, the light guide plate 22 of the light source unit 16 that is adjacent to the light guide portion 23 does not overlap the light guide portion 23. This enables each light guide plate 22 to be separately mounted or removed.

In the liquid crystal display device 10 of the present embodiment, the light path length of light traveling through the light guide plate 22 of the light source unit 16 is sufficiently ensured and unevenness is less likely to occur in the light exiting through the light exit surface 27. Therefore, the backlight unit 12 that supplies light to the liquid crystal panel 11 achieves display with excellent display quality. Further, a number of light guide plates 22 of the backlight unit 12 can be separately mounted or removed, and this reduces a manufacturing cost of the liquid crystal display device.

The light source units 16 are arranged in series in at least the above-mentioned arrangement direction. Accordingly, the device can be easily increased in size in the arrangement direction of the LED 20 and the light entrance surface 26.

The LED 20 is arranged on the first end portion side of two ends of the light guide plate 22 in the arrangement direction. The light guide plate 22 is configured such that the light guide portion 23 and the light exit portion 24 are optically connected to each other and the guidance reflecting member 31 is provided on the second end portion side in the arrangement direction. The light guide portion 23 and the light exit portion 24 are optically independent from each other on the first end portion side. Accordingly, the light guide portion 23 and the light exit portion 24 of the light guide plate 22 are optically connected to each other only on the second end portion side in the arrangement direction and the guidance reflecting member 31 provided on the second end portion side guides light from the light guide portion 23 to the light exit portion 24.

The light guide plates 22 that are arranged in series in the arrangement direction are provided such that the first end portion of one light guide plate 22 and the second end portion of another adjacent light guide plate 22 are opposed to each other. The light guide plates 22 each of which has directivity are arranged in series so as to head for the same direction. This simplifies the assembling operations.

The first end portion and the second end portion are formed in complementary shapes. This reduces a gap between the light exit surfaces 27 of the adjacent light guide plates 22 that can be a dark portion to a minimum. This effectively prevents uneven brightness.

The guidance reflecting member 31 is provided as a light blocking member that optically separates the light guide plates 22 that are adjacent to each other in the arrangement direction. Therefore, turning on and off of each of the light source units 16 can be controlled individually. Additionally, the guidance reflecting member 31 has a function of the light blocking member. Compared to the case in which the light blocking member and the guidance reflecting member are separately provided, the number of components and a cost are reduced.

The first reflecting member 28 is integrally formed with the guidance reflecting member 31. The guidance reflecting member 31 is provided between the light source units 16 that are arranged in adjacent to each other in the arrangement direction. Thus, the guidance reflecting member 31 is integrally formed with the first reflecting member 28. This further reduces the number of components and a cost.

The light source units 16 are arranged in series in the arrangement direction (the X-axis direction) and in a direction along the light exit surface 27 and perpendicular to the arrangement direction (the Y-axis direction). Accordingly, the device increases in size two-dimensionally.

An air layer AR is provided between the light guide plates 22 that are in adjacent to each other in the direction along the light exit surface 27 and perpendicular to the arrangement direction. The air layer AR is a low refractive index layer having a refractive index lower than the light guide plate 22. Accordingly, the rays of light traveling through the light guide plate 22 are totally reflected at the border surface between the light guide plate 22 and the air layer AR that is the low refractive index layer. Therefore, the rays of light traveling though the adjacent light guide plates 22 are not mixed with each other. This enables to control light emission from the light exit surface 27 of each light guide plate 22 separately and individually. Additionally, a special member for forming the low light refractive index layer is not required, and this reduces a cost.

The guidance reflecting members 31 that are arranged in adjacent to each other in the direction along the light exit surface 27 and perpendicular to the arrangement direction are provided in a different positions in the arrangement direction. Accordingly, the guidance reflecting member 31 is less likely to be recognized as relatively a dark portion between the light exit surfaces 27 of the light guide plates 22. This effectively prevents uneven brightness.

The guidance reflecting member 31 is formed to be slanted to an axis along a direction perpendicular to the light exit surface 27. Accordingly, the slanted angle of the guidance reflecting member 31 is controlled to efficiently guide the light from the light guide portion 23 to the light exit portion 24.

The guidance reflecting member 31 is configured by the first guidance reflecting member 31a and the second guidance reflecting member 31b. The first guidance reflecting member 31a is slanted at an obtuse angle to the light exit surface 27 and the second guidance reflecting member 31b is slanted at an obtuse angle to the surface of the light guide plate 22 opposite from the light exit surface 27. With this configuration, the light from the light guide portion 23 is guided to the light exit portion 24 more efficiently.

The border between the first guidance reflecting member 31a and the second guidance reflecting member 31b is located at a substantially same position in the direction perpendicular to the light exit surface 27. With this configuration, a maximum gap is ensured between the first reflecting member 28 and the guidance reflecting member 31. Accordingly, light is efficiently guided from the light guide portion 23 to the light exit portion 24.

The second reflecting member 29 that reflects light is provided on the light guide portion 23 on a side opposite from the first reflecting member 28. With this configuration, the reflecting members 28, 29 reflect light traveling through the light guide portion 23 such that the light efficiently travels through the light guide portion 23.

The light guide portion 23 and the light exit portion are integrally formed therewith. This simplifies the assembling operation.

One of the facing surfaces of the light guide portion 24 and the first reflecting member 28 has the scattering surface 30 as the scattering structure that scatters light. With this configuration, light traveling through the light exit portion 24 is scattered by the scattering structure to exit through the light exit surface 27 efficiently.

The connecting portion 25 optically connects the light guide portion 23 and the light exit portion 24. The scattering structure is configured such that the degree of light scattering increases in a continuous and gradual manner as is farther from the connecting portion 25 in the arrangement direction. With this configuration, the amount of rays of light traveling through the light exit portion 24 is relatively greater in a portion closer to the connecting portion 25 than a portion farther from the connecting portion 25 in the arrangement direction in which the LED 20 and the light entrance surface 26 are arranged. The degree of light scattering of the scattering structure is relatively lower in the portion of the light exit portion 24 close to the connecting portion 25 having a greater amount of rays of light to reduce the amount of rays of light exiting through the portion of the light exit portion 24. The degree of light scattering of the scattering structure is relatively higher in the portion of the light exit portion 24 farther from the connecting portion 25 having a smaller amount of rays of light to increase the amount of rays of light exiting through the portion of the light exit portion 24. This unifies a brightness distribution of light in a surface area that exits through the light exit surface 27. Uneven brightness is less likely to be caused.

The light source is the LED 20. This improves brightness.

The LED 20 includes a plurality kinds of LED chips with different main emission wavelengths. With this configuration, the light path length of light traveling through the light guide plate 22 is sufficiently ensured. Therefore, rays of light emitted from each LED chip are effectively mixed while traveling through the light guide plate 22. Uneven coloring is less likely to be caused in the rays of light emitted through the light exit surface 27.

The present invention is not limited to the embodiment explained in the above description. The following modifications may be included in the technical scope of the present invention, for example. In the following modifications, the same components as the first embodiment will be indicated with the same symbols. The same configuration, functions and effects will not be explained.

### First Modification of First Embodiment

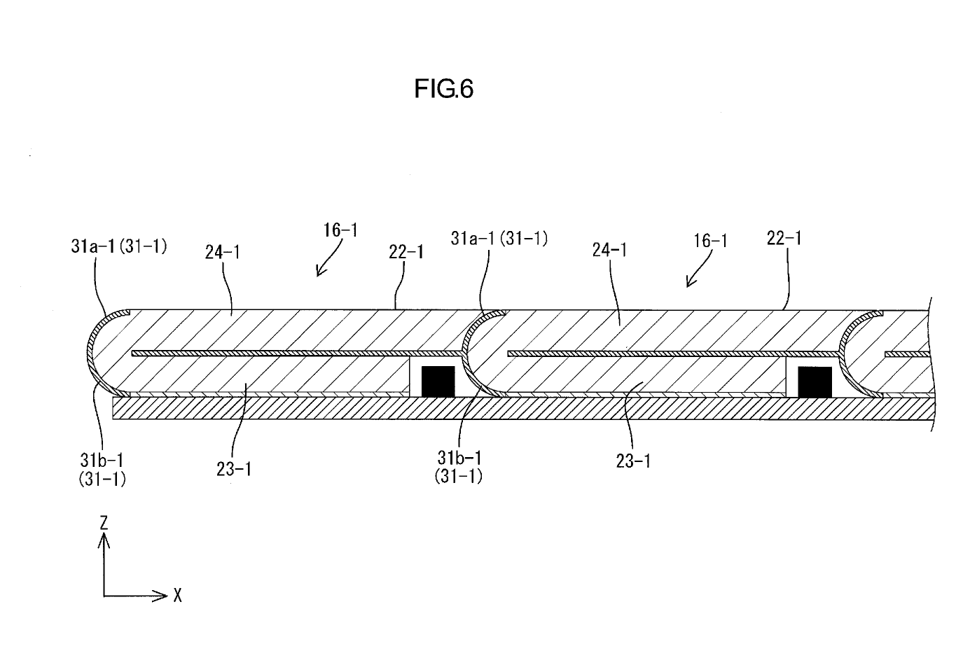

A first modification of the first embodiment will be explained with reference to FIG. 6. In the first modification, a light guide plate 22-1 and a guidance reflecting member 31-1 of a light source unit 16-2 are formed in different shapes from those of the first embodiment.

As illustrated in FIG. 6, in the first modification, the front end surface of the light guide plate 22-1 is formed in substantially an arc shape with a cross-sectional view, and the guidance reflecting member 31-1 that is provided along the front end surface is also formed in substantially an arc shape with a cross-sectional view. A first guidance reflecting member 31a-1 and a second guidance reflecting member 31b-1 of the guidance reflecting member 31-1 are formed with same curvature. The curvature is appropriately set to guide light from a light guide portion 23-1 to a light exit portion 24-1 side.

### Second Modification of First Embodiment

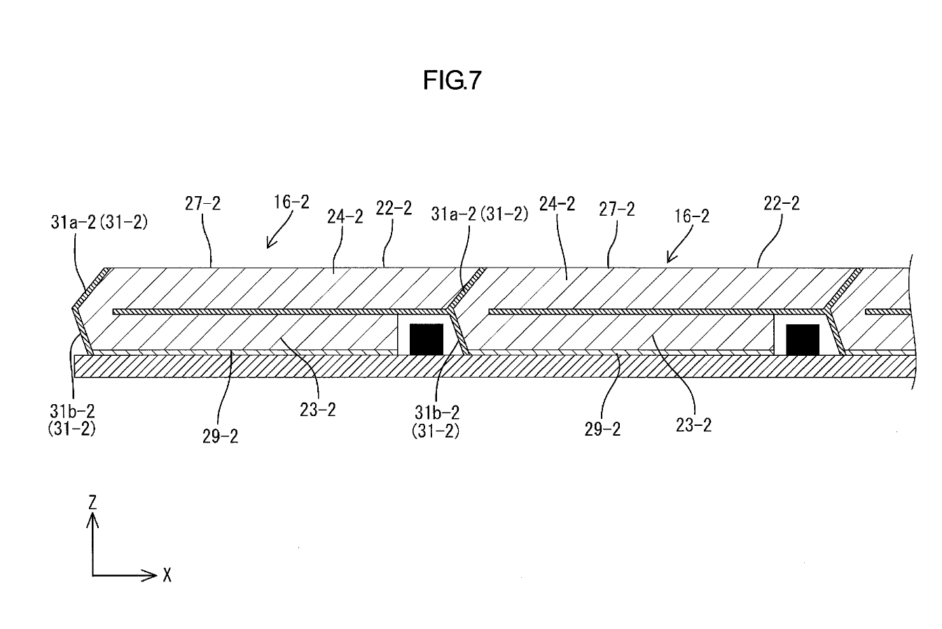

A second modification of the first embodiment will be explained with reference to FIG. 7. In the second modification, a light guide plate 22-2 and a guidance reflecting member 31-2 of a light source unit 16-2 are formed in different shapes from those of the first embodiment.

In the second modification, as illustrated in FIG. 7, an angle formed between the light exit surface 27-2 and a slanted surface of the front end surface of the light guide plate 22-2 on a relatively front-surface side or a first guidance reflecting member 31a-2 of the guidance reflecting member 31-2 is different from an angle formed between a second reflecting member 29-2 and a slanted surface of the front end surface of the light guide plate 22-2 on a relatively rear-surface side or a second guidance reflecting member 31b-2 of the guidance reflecting member 31-2. Specifically, an angle formed between the first guidance reflecting member 31a-2 is greater than an angle formed between the second guidance reflecting member 31b-2 and the second reflecting member 29-2. Because the slanted angle of the first guidance reflecting member 31a-2 and the slanted angle of the second guidance reflecting member 31b-2 are different from each other, rays of light are efficiently guided from the light guide portion 23-2 to the light exit portion 24-2. Unlike the example illustrated in FIG. 7, the angle formed between the first guidance reflecting member 31a-2 and the light exit surface 27-2 may be set to be smaller than the angle formed between the second guidance reflecting member 31b-2 and the second reflecting member 29-2.

### Third Modification of First Embodiment

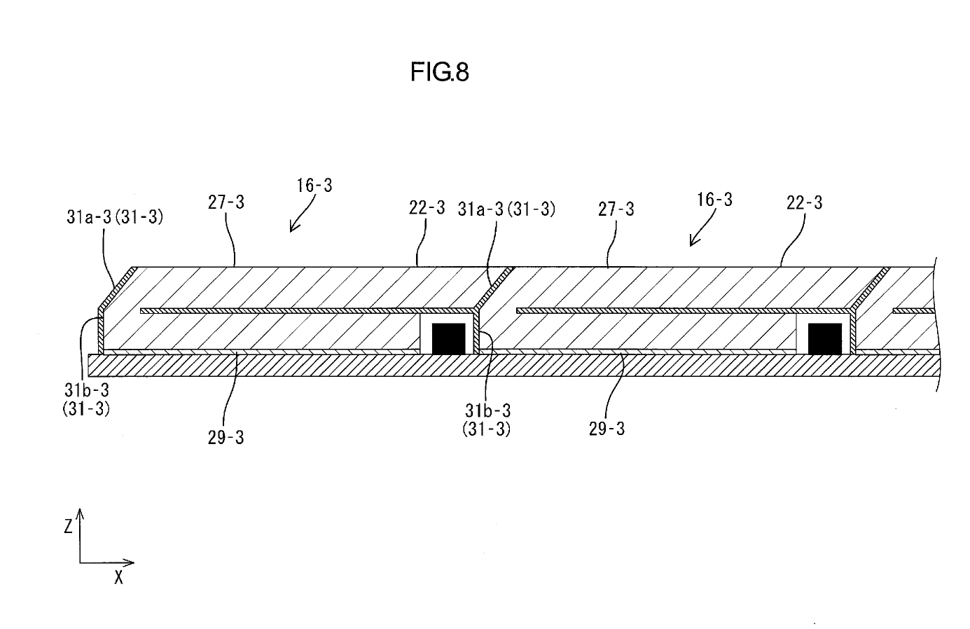

A third modification of the first embodiment will be explained with reference to FIG. 8. In the third modification, a light guide plate 22-3 and a guidance reflecting member 31-3 of a light source unit 16-3 are formed in different shapes from those of the first embodiment.

In the third modification, as illustrated in FIG. 8, an obtuse angle is formed between a light exit surface 27-3 and a slanted angle of the front end surface of the light guide plate 22-3 on a relatively front-surface side or a first guidance reflecting member 31a-3 of the guidance reflecting member 31-3, and substantially a right angle is formed between a second reflecting member 29-3 and a slanted surface of the front end surface of the light guide plate 22-3 on a relatively rear-surface side or a second guidance reflecting member 31b-3 of the guidance reflecting member 31-3.

### Fourth Modification of First Embodiment

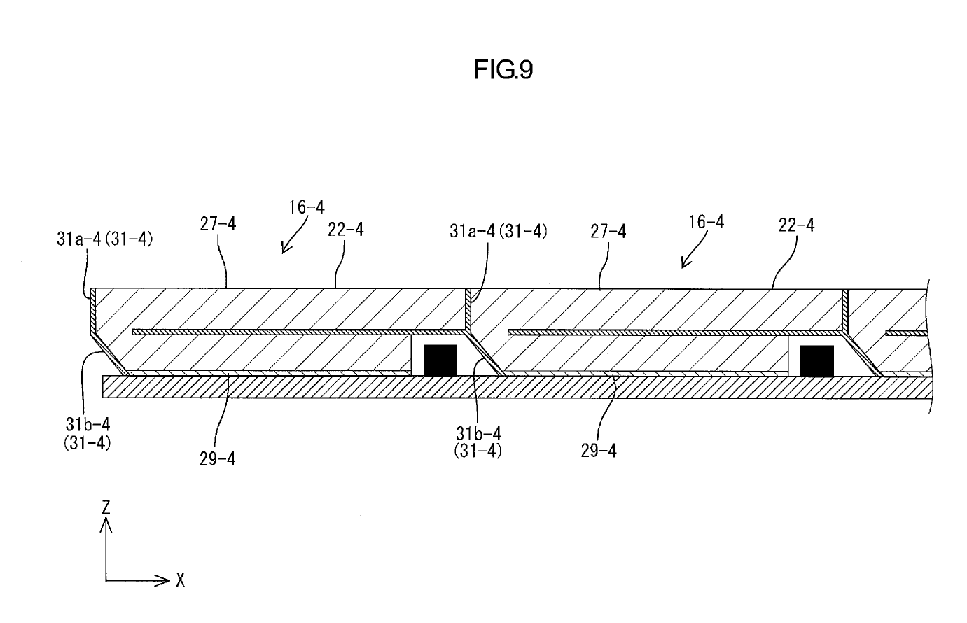

A fourth modification of the first embodiment will be explained with reference to FIG. 9. In the fourth modification, a light guide plate 22-4 and a guidance reflecting member 31-4 of a light source unit 16-4 are formed in different shapes from those of the first embodiment.

In the fourth modification, as illustrated in FIG. 9, an obtuse angle is formed between a second reflecting member 29-4 and a slanted angle of the front end surface of the light guide plate 22-4 on a relatively rear-surface side or a second guidance reflecting member 31b-4 of the guidance reflecting member 31-4, and substantially a right angle is formed between a light exit surface 27-4 and a slanted surface of the front end surface of the light guide plate 22-4 on a relatively front-surface side or a first guidance reflecting member 31a-4 of the guidance reflecting member 31-4.

### Fifth Modification of First Embodiment

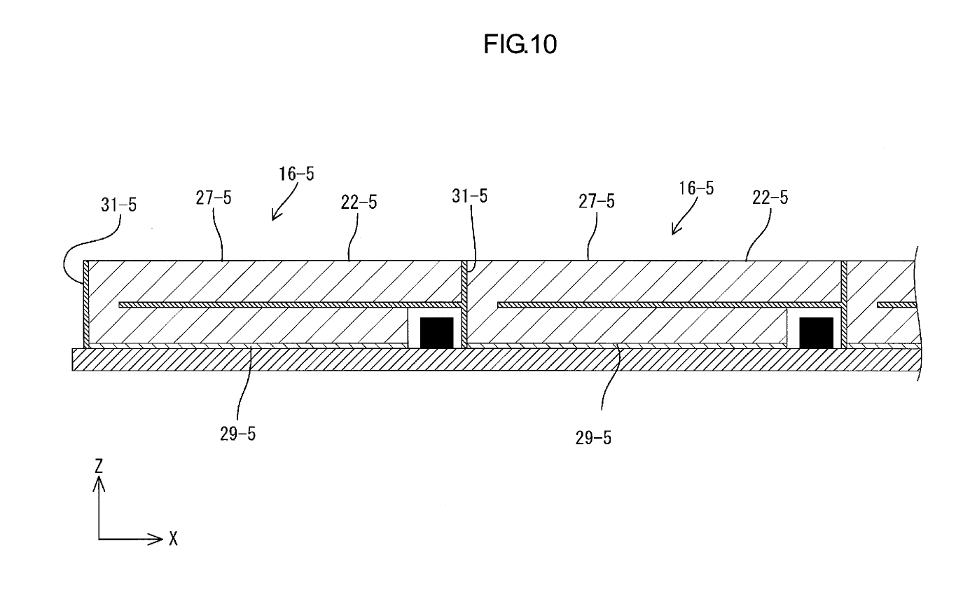

A fifth modification of the first embodiment will be explained with reference to FIG. 10. In the fifth modification, a light guide plate 22-5 and a guidance reflecting member 31-5 of a light source unit 16-5 are formed in different shapes from those of the first embodiment.

In the fifth modification, as illustrated in FIG. 10, entire areas of the front end surface of the light guide plate 22-5 and the guidance reflecting member 31-5 are formed in flat surfaces along the Z-axis direction. Angles formed between the guidance reflecting member 31-5 and a light exit surface 27-5 and between the guidance reflecting member 31-5 and a second reflecting member 29-5 are approximately 90 degrees.

### Second Embodiment

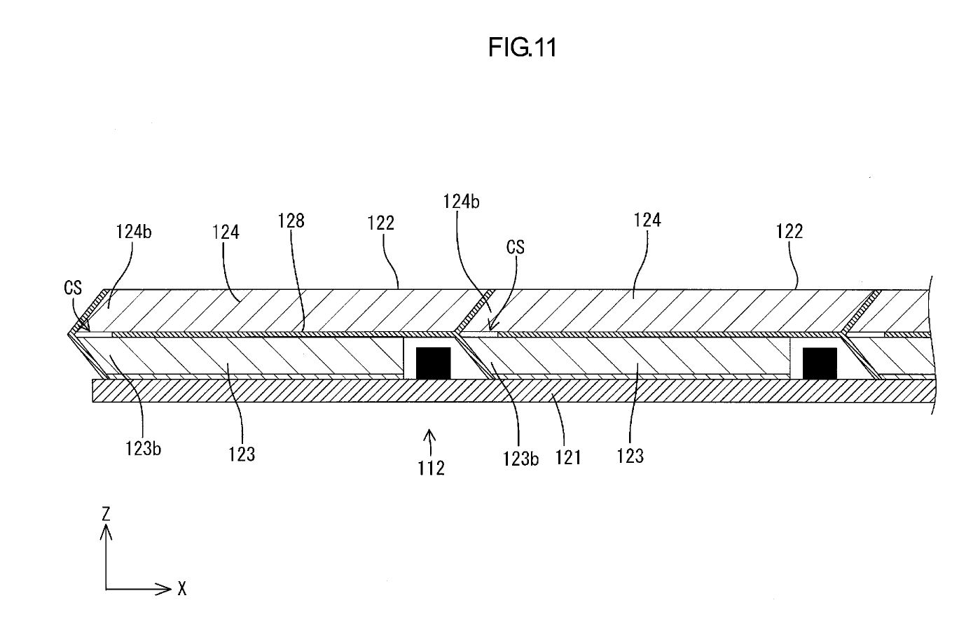

A second embodiment of the present invention will be explained with reference to FIG. 11. According to the second embodiment, a light guide portion 123 and a light exit portion 124 of a light guide plate 122 are formed separately from each other. In the second embodiment, the same configuration, functions and effects will not be explained.

As illustrated in FIG. 11, the light guide plate 122 is configured by two components of the light guide portion 123 and the light exit portion 124. Namely, the light guide plate 122 of the second embodiment is configured by the light guide plate 22 of the first embodiment excluding the connecting portion 25. Therefore, in manufacturing the light guide plate 122, the light guide portion 123 and the light exit portion 124 are molded by different molds and a first reflecting member 128 can be provided between the light guide portion 123 and the light exit portion 124 easily. In mounting the first reflecting member 128, an operator can selectively mount the first reflecting member 128 on the light guide portion 123 or the light exit portion 124. Further, following assembling methods can be applied. In one assembling method, after the light guide portion 123, the light exit portion 124 and the first reflecting member 128 are assembled to each other, the assembly is mounted to an LED board 121. In another assembling method, the light guide portion 123, the light exit portion 124 and the first reflecting member 128 are assembled to the LED board 121 in a predetermined order. According to the second embodiment, the light guide plate 122 may be manufactured in various manufacturing steps and a backlight unit 112 may be assembled in various methods.

Front end portions 123b, 124b of the light guide portion and the light exit portion 124 are opposed to each other and a connecting space CS that is an air layer is formed therebetween. Namely, the light guide portion 123 and the light exit portion 124 are not mechanically connected to each other but optically connected to each other via the connecting space CS. Accordingly, rays of light are effectively guided from the light guide portion 123 to the light exit portion 124 via the connecting space CS.

As explained above, according to the second embodiment, the light guide portion 123 and the light exit portion 124 are formed separately from each other, and this increases variety in the assembling operations.

### Third Embodiment

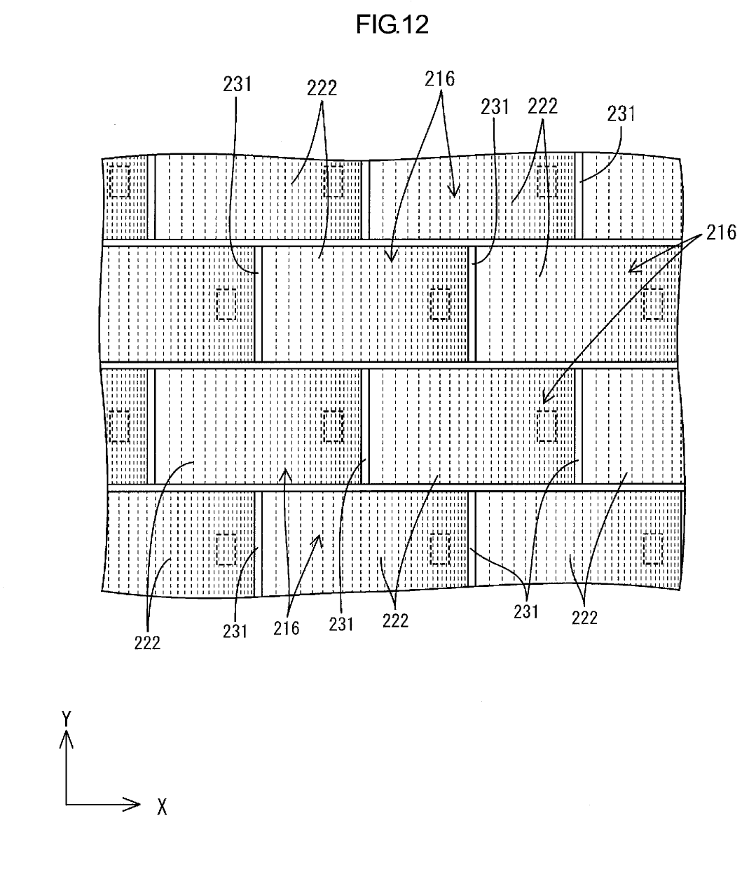

A third embodiment of the present invention will be explained with reference to FIG. 12. According to the third embodiment, a layout of light source units 216 is changed from the first embodiment. In the third embodiment, the same configuration, functions and effects will not be explained.

As illustrated in FIG. 12, each of the light source units 216 that are adjacent to each other in the Y-axis direction is offset from each other in the X-axis direction. An offset amount of the light source units 216 that are adjacent to each other in the Y-axis direction is approximately a half of a length of the light guide plate 222 in the X-axis direction. The light source units 216 are arranged in a zigzag with a planar view. The light source units 216 are arranged in the X-axis direction in two layout patterns. The light source units 216 of each layout pattern are arranged alternately in the Y-axis direction such that the light source units 216 are arranged in series two-dimensionally. A guidance reflecting member 231 is provided between the light guide plates 222 that are arranged in adjacent to each other in the X-axis direction. The guidance reflecting member 231 is located in substantially a middle portion of the adjacent light guide plate 222 in the X-axis direction. Accordingly, the guidance reflecting members 231 that may be relatively dark portions compared to the light exit surface 27 are not continuously arranged in the Y-axis direction. This prevents occurrence of uneven brightness.

### Fourth Embodiment

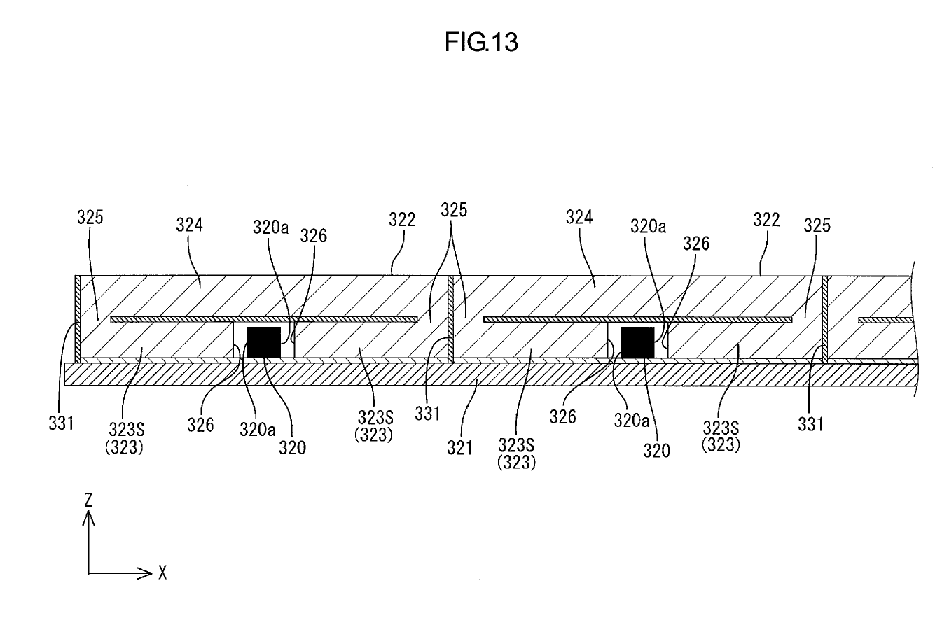

A fourth embodiment of the present invention will be explained with reference to FIG. 13. In the fourth embodiment, a light guide plate 322 and an LED 320 are configured differently. In the fourth embodiment, the same configuration, functions and effects will not be explained.

As illustrated in FIG. 13, a light guide portion 323 of the light guide plate 322 is separated into two portions including separate light guide portions 323S on front and rear sides. Each of the separate light guide portion 323S has a light entrance surface 326. The light guide portion 323 is separated into two portions at a middle portion in the X-axis direction. An LED housing space S is formed between the separate light guide portions 323S and an LED 320 is housed therein. The light entrance surfaces 326 of the separate light guide portions 323S are opposed to each other. An end portion of each separate light guide portion 323S opposite from the light entrance surface 326 is mechanically and optically connected to the light exit portion 324 via a connecting portion 325. Namely, two connecting portions 325 are provided on two end portions of the light guide plate 322 in the X-axis direction, respectively. The LED 320 has light emitting surfaces on side surfaces each facing the light entrance surface 326. Namely, the LED 320 is a side-surface light emission type LED in which two side surfaces adjacent to a mounting surface to the LED board 321 are light emitting surfaces 320a. A guidance reflecting member 331 is similar to that of the fifth modification of the first embodiment and is not explained.

### Other Embodiments

The present invention is not limited to the above embodiments explained in the above description. The following embodiments may be included in the technical scope of the present invention, for example.

(1) In the above embodiments, the LED is configured to include three kinds of LED chips with different main wavelengths. The LED may include an LED chip with one main wavelength. Specifically, each LED includes an LED chip emitting single color light of R, G or B. Such single-light emission type LEDs are dispersed in a surface area of the light emitting surface of the backlight unit. With such a configuration, a light path length of light traveling through the light guide plate is sufficiently ensured. This unifies a brightness distribution of single light emitted from each LED chip and exiting through the light exit surface in a surface area of the light exit surface.

(2) In the above embodiments, the first guidance reflecting member and the second guidance reflecting member of the guide reflecting member are integrally formed with the first reflecting member. The guidance reflecting member may be partially integrally formed with the first reflecting member. Specifically, only the first guidance reflecting member of the guidance reflecting member is integrally formed with the first reflecting member and the second guidance reflecting member may be formed separately from the first reflecting member. In such a configuration, it is preferable that the second guidance reflecting member is integrally formed with the second reflecting member. Further, the guidance reflecting member may be provided separately from the first reflecting member and the second reflecting member.

(3) In the above embodiments, the LED is arranged on a rear end side of the optical unit or in a middle portion of the optical unit in the front-and-rear direction. The LED may be arranged in other positions if necessary.

(4) In the above embodiments, side-surface light emission type LEDs are used. Other type of LEDs such as bullet LEDs may be used.

(5) In the above embodiments, each LED includes three different LED chips configured to emit respective colors of RGB. However, LEDs each including a single LED chip configured to emit a single color of blue or violet and each configured to emit white light using fluorescent material may be used.

(6) In the above embodiments, each LED includes three different LED chips configured to emit respective colors of RGB. However, LEDs each including three different LED chips configured to emit respective colors of cyan (C), magenta (M) and yellow (Y) may be used.

(7) In the above embodiments, the guidance reflecting member functions as a light blocking member that optically separates the light source units that are arranged in adjacent to each other in the front-and-rear direction. The light blocking property may be excluded from the guidance reflecting member and a light blocking member may be provided separately from the guidance reflecting member.

(8) In the above embodiments, the second reflecting member is provided. The second reflecting member may be omitted as long as a surface of the LED board, for example, has sufficient light reflectivity.

(9) In the above embodiments, the first reflecting member includes the scattering structure. Instead, the scattering structure may be provided on a surface of the light exit portion facing the first reflecting member. The scattering structure may be provided both of the facing surfaces of the first reflecting member and the light exit portion.

(10) In the above embodiments, the scattering structure is configured by perforations formed along the Y-axis direction. The scattering structure may be configured by recesses and projections of a dot pattern (including a rough surface).

(11) In the above embodiments, the light source units are two-dimensionally arranged in series in the chassis. The light source units may be one-dimensionally arranged in series in the chassis. Specifically, the light source units may be arranged in series only in the X-axis direction or may be arranged in series only in the Y-axis direction.

(12) In the above embodiments, the air layer is used as the low refractive index layer. A low refractive index layer made of a low refractive index material may be provided between the light guide plates that are arranged in adjacent to each other in the Y-axis direction.

(13) In the above embodiments, the LEDs are used as point light sources. Point light sources other than the LEDs may be used.

(14) In the above embodiments, the LEDs that are point light sources are used as the light sources. A linear light source such as a cold cathode tube or a hot cathode tube may be used as the light source. In such a case, one linear light source may be arranged to face the light entrance surfaces of the light guide plates that are arranged in series in a row such that light is supplied collectively to the light guide plates.

(15) Unlike the above embodiments and other embodiments (13) and (14), a planer light source such as an organic EL may be used as the light source.

(16) The optical member may be configured differently from the above embodiments. Specifically, the number of diffusers or the number and the kind of the optical sheets can be altered as necessary. Furthermore, a plurality of optical sheets in the same kind may be used.

(17) In the above embodiments, the liquid crystal panel and the chassis are held in the vertical position with the short-side direction thereof aligned with the vertical direction. However, the liquid crystal panel and the chassis may be held in the vertical position with the long-side direction thereof aligned with the vertical direction.

(18) In the above embodiments, the long-side direction of the light guide plate matches the X-axis direction (the horizontal direction) and the short-side direction of the light guide plate matches the Y-axis direction (the vertical direction). The long-side direction of the light guide plate may match the Y-axis direction (the vertical direction) and the short-side direction of the light guide plate may match the X-axis direction (the horizontal direction).

(19) In the above embodiments, the chassis is made of metal but may be made of resin.

(20) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(21) In the above embodiments, the liquid crystal display device including the liquid crystal panel as a display component is used in the above embodiment. The technology can be applied to display devices including other types of display components.

(22) In the above embodiments, the television receiver including the tuner is used. However, the technology can be applied to a display device without a tuner.

1. A lighting device comprising:
a plurality of light source units, each of the light source units including:
a light source;
a light guide member including a light guide portion and a light exit portion, the light guide portion including a light entrance surface that is provided to face the light source and light emitted from the light source enters, and the light exit portion including a light exit surface that is provided to be parallel to an arrangement direction in which the light source and the light entrance surface are arranged and through which light exits, the light exit portion overlapping the light guide portion in a direction perpendicular to the light exit surface and provided on relatively a light exit side and optically continuous from the light guide portion;
a reflecting member provided between the light guide portion and the light exit portion and configured to reflect light; and
a guidance reflecting member configured to reflect the light from the light guide portion to guide the light to the light exit portion,
wherein the light source units are arranged in series in one direction along the light exit surface.

2. The lighting device according to claim 1, wherein the light source units are arranged in series in the arrangement direction.

3. The lighting device according to claim 2, wherein:
the light guide member has a first end portion and a second end portion in the arrangement direction, the light source is arranged on a first end portion side;
the light guide portion and the light exit portion are optically connected to each other on a second end portion side and the guidance reflecting member is provided on the second end portion side; and
the light guide portion and the light exit portion are optically independent from each other on the first end portion side.

4. The lighting device according to claim 3, wherein the light guide members are arranged in series in the arrangement direction such that the first end portion of one of the light guide members faces the second end portion of adjacent another one of the light guide members.

5. The lighting device according to claim 4, wherein the first end portion and the second end portion are formed in complementary shapes.

6. The lighting device according to claim 4, further comprising a light blocking member configured to make the light guide members that are arranged in adjacent to each other in the arrangement direction to be optically independent from each other.

7. The lighting device according to claim 6, wherein the light blocking member is configured by the guidance reflecting member provided between the light source units that are arranged in adjacent to each other in the arrangement direction.

8. The lighting device according to claim 7, wherein the reflecting member is integrally formed with the guidance reflecting member provided between the light source units that are arranged in adjacent to each other in the arrangement direction.

9. The lighting device according to claim 1, wherein the light source units are arranged in the arrangement direction and in a direction along the light exit surface and perpendicular to the arrangement direction.

10. The lighting device according to claim 9, wherein a low refractive index layer having a refractive index lower than the light guide member is provided between the light guide members that are arranged in adjacent to each other in the direction along the light exit surface and perpendicular to the arrangement direction.

11. The lighting device according to claim 10, wherein the low refractive index layer is an air layer.

12. The lighting device according to claim 9, wherein the guidance reflecting members that are provided in adjacent to each other in the direction along the light exit surface and perpendicular to the arrangement direction are provided in different positions in the arrangement direction.

13. The lighting device according to claim 1, wherein the guidance reflecting member is formed to be slanted to an axis along a direction perpendicular to the light exit surface.

14. The lighting device according to claim 13, wherein the guidance reflecting member includes a first guidance reflecting member and a second guidance reflecting member, the first guidance reflecting member makes an obtuse angle with the light exit surface and the second guidance reflecting member makes an obtuse angle with a surface of the light guide member opposite from the light exit surface.

15. The lighting device according to claim 14, wherein a border between the first guidance reflecting member and the second guidance reflecting member is substantially on a same position as the reflecting member in a direction perpendicular to the light exit surface.

16. The lighting device according to claim 1, further comprising a second reflecting member provided on the light guide portion on a side opposite from the reflecting member and configured to reflect light.

17. The lighting device according to claim 1, wherein the light guide portion and the light exit portion are integrally formed with each other.

18. The lighting device according to claim 1, wherein the light guide portion and the light exit portion are formed separately from each other.

19. The lighting device according to claim 1, further comprising a scattering structure provided on one of facing surfaces of the light exit portion and the reflecting member and configured to scatter light.

20. The lighting device according to claim 19, further comprising a connecting portion configured to optically connect the light guide portion and the light exit portion, wherein the scattering structure is configured such that a degree of light scattering increases in a continuous and gradual manner as is getting farther from the connecting portion in the arrangement direction.

21. The lighting device according to claim 1, wherein the light source is an LED.

22. The lighting device according to claim 21, wherein the LED includes a number of kinds of LED chips having different main emission wavelengths.

23. The lighting device according to claim 21, wherein the LED includes an LED chip having one kind of main emission wavelength.

24. A display device comprising:
the lighting device according to claim 1; and
a display panel configured to provide display using light from the lighting device.

25. The display device according to claim 24, wherein the display panel is a liquid crystal panel including liquid crystals sealed between a pair of substrates.

26. A television receiver comprising the display device according to claim 24.
